(19) United States
(12) Patent Application Publication
(10) Pub. No.: US 2022/0347969 A1
(43) Pub. Date: Nov. 3, 2022

(54) GLASS LAMINATE ARTICLE

(71) Applicant: Corning Incorporated, Corning, NY (US)

(72) Inventors: Jhee-mann Kim, Yongin-Si (KR); Goo Soo Lee, Seoul (KR)

(21) Appl. No.: 17/773,342

(22) PCT Filed: Oct. 22, 2020
(86) PCT No.: PCT/US2020/056761

§ 371 Date: Apr. 29, 2022

(30) Foreign Application Priority Data
Oct. 29, 2019 (KR) 10-2019-0135762

(51) Int. Cl. B32B 7/12; B32B 27/06; B32B 15/08; B32B 15/04; B32B 17/10

(52) U.S. Cl. CPC B32B 7/12; B32B 27/065; B32B 15/08; B32B 15/046; B32B 17/10; B32B 2250/05; B32B 2250/04; B32B 2264/102; B32B 2307/306; B32B 2307/732; B32B 2479/00; B32B 2419/00; B32B 2307/4026

(57) ABSTRACT

Provided is a glass laminate article including a core substrate having a first surface, a second surface opposite to the first surface, and a side surface between the first surface and the second surface; a first metal sheet on the first surface; a second metal sheet on the second surface; a glass substrate on the second metal sheet; and an adhesive member bonding the glass substrate to the second metal sheet, wherein the core substrate has lower thermal conductivity than a medium density fiberboard (MDF).

### CROSS-REFERENCE TO RELATED APPLICATION

This application claims the benefit of Korean Patent Application No. 10-2019-0135762, filed on Oct. 29, 2019, in the Korean Intellectual Property Office, the disclosure of which is incorporated herein in its entirety by reference.

### BACKGROUND

### 1. Field

One or more embodiments relate to a glass laminate article, and more particularly, to a glass laminate article having high insulation performance and low bowing.

### 2. Description of Related Art

To apply glass laminate articles to building or furniture materials, it may be necessary that characteristics of glass laminate articles do not change significantly despite changes in an ambient environment. Other properties of glass laminate articles may also be required. It will be better when these requirements are all satisfied simultaneously.

### SUMMARY

One or more embodiments include a glass laminate article having high insulation performance and low bowing.

Additional aspects will be set forth in part in the description which follows and, in part, will be apparent from the description, or may be learned by practice of the presented embodiments of the disclosure.

According to one or more embodiments, a glass laminate article includes a core substrate having a first surface, a second surface opposite to the first surface, and a side surface between the first surface and the second surface; a first metal sheet on the first surface; a second metal sheet on the second surface; a glass substrate on the second metal sheet; and an adhesive member bonding the glass substrate to the second metal sheet, wherein the core substrate has lower thermal conductivity than a medium density fiberboard (MDF).

In some embodiments, the core substrate may include a polymer having a foam structure. In some embodiments, the core substrate may include a composite material including a metal oxide and/or a semimetal oxide. The composite material may include silica, titania, alumina, zirconia, and/or ceria.

In some embodiments, the first metal sheet and the second metal sheet each may be an aluminum sheet and/or an aluminum alloy. At this time, the glass laminate article may further include an image layer between the second metal sheet and the adhesive member. In some embodiments, a thickness of the first metal sheet may be about 0.2 mm to about 0.8 mm. At this time, the thickness of the first metal sheet may be substantially equal to a thickness of the second metal sheet. In some embodiments, the glass substrate may have a thickness of about 0.1 mm to about 0.7 mm.

According to one or more embodiments, a glass laminate article includes a core substrate having a first surface, a second surface opposite to the first surface, and a side surface between the first surface and the second surface; a first sheet on the first surface, the first sheet having a thickness of about 0.2 mm to about 0.8 mm; a glass substrate on the second surface; and an adhesive member between the second surface and the glass substrate, wherein the first sheet may include an aluminum sheet and/or an aluminum alloy sheet.

In some embodiments, the glass laminate article may further include a second sheet between the second surface and the adhesive member, wherein the second sheet may include an aluminum sheet and/or an aluminum alloy sheet. At this time, a thickness of the second sheet may be substantially equal to the thickness of the first sheet.

In some embodiments, thermal transmittance of the core substrate may be less than 18 W/m²K. In some embodiments, the glass substrate may include aluminosilicate, alkali-aluminosilicate, borosilicate, alkali-borosilicate, aluminoborosilicate, alkali-aluminoborosilicate, soda lime glass, and/or alkali-free glass. In some embodiments, the adhesive member may include ethylene-vinyl acetate resin, poly(vinyl butyral), ultraviolet (UV) curable resin, and/or an optically clear adhesive (OCA).

According to one or more embodiments, a glass laminate article includes a core substrate having a thermal transmittance of less than 18 W/m²K; a first metal sheet and a second metal sheet respectively on opposite surfaces of the core substrate and each having a thickness of about 0.2 mm to about 0.8 mm; and a glass substrate on the first metal sheet.

In some embodiments, the glass laminate article may further include an image layer between the glass substrate and the first metal sheet. At this time, a thickness of the glass substrate may be about 0.1 mm to about 0.7 mm.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an exploded perspective view of a glass laminate article according to an embodiment;

FIG. 2 is a cross-sectional view of the glass laminate article of FIG. 1 taken along line II-II′, according to an embodiment;

FIG. 3 is an exploded perspective view of a glass laminate article according to one or more embodiments; and

FIG. 4 is a schematic diagram illustrating directions in which the bowing of a glass laminate article is measured, according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, integers, steps, operations, elements, components, and/or combinations thereof, but do not preclude the presence or addition of one or more other features, regions, integers, steps, operations, elements, components, and/or combinations thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

When it is possible to modify an embodiment, the order of processes may be different from the order in which the processes have been described. For instance, two processes described as being performed sequentially may be substantially performed simultaneously or in a reverse order.

In the drawings, transformation of the shapes may be expected according to, for example, manufacturing techniques and/or tolerance. Accordingly, embodiments should not be construed as being limited to specified shapes in the drawings but as including changes in the shapes occurring during, for example, manufacturing processes. As used herein, the term “and/or” includes any and all combinations of one or more of the associated listed items. In addition, the term “substrate” used herein may refer to a substrate itself or a stack structure that includes a substrate and a certain layer or film formed on a surface of the substrate. The expression “surface of the substrate” may refer to an exposed surface of the substrate itself or an outer surface of a certain layer or film formed on the substrate.

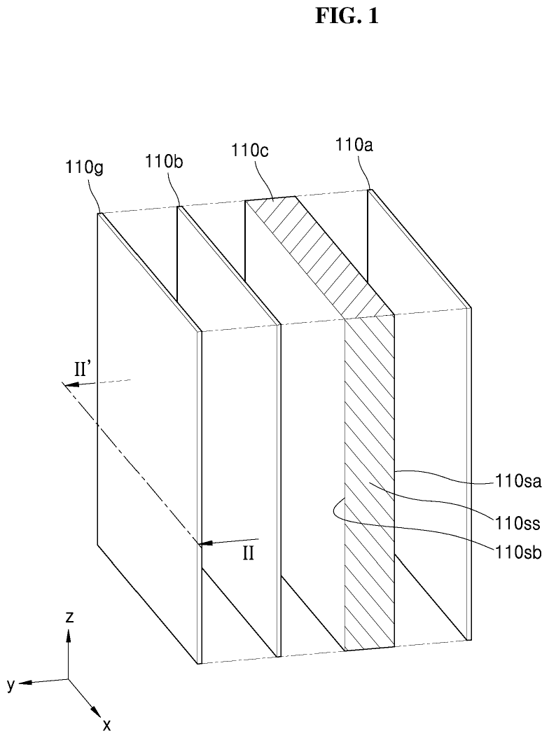

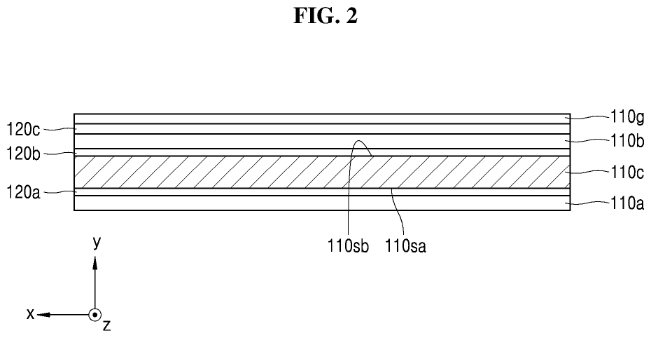

FIG. 1 is an exploded perspective view of a glass laminate article 100 according to an embodiment. FIG. 2 is a cross-sectional view of the glass laminate article 100, taken along line II-II′.

Referring to FIGS. 1 and 2, the glass laminate article 100 may include a core substrate 110c, a first metal sheet 110a, a second metal sheet 110b, and a glass substrate 110g.

The core substrate 110c includes a first surface 110sa, a second surface 110sb, and a side surface 110ss extending between the first surface 110sa and the second surface 110sb. The first surface 110sa and the second surface 110sb may be oppositing two main surfaces of the core substrate 110c, and may be substantially parallel with an xz plane. The side surface 110ss may be a surface between the first surface 110sa and the second surface 110sb and may be parallel with a y-axis.

In some embodiments, the core substrate 110c may include a polymer having a foam structure. The polymer having a foam structure may include polystyrene foam, polystyrene foam, polyethylene foam, polyurethane foam, or polypropylene foam but is not limited thereto.

In some embodiments, the core substrate 110c may include a composite material of a metal oxide or a semimetal oxide. The semimetal oxide may include silica. The metal oxide may include titania, alumina, zirconia, or ceria.

The metal oxide or the semimetal oxide may be in powder form and thus be immobilized with a binder such that the metal oxide or the semimetal oxide is molded into a panel shape.

For example, the binder may include cellulose resin such as ethyl cellulose, hydroxyethyl cellulose, ethylhydoxy cellulose, hydroxypropyl cellulose, methyl cellulose, cellulose acetate, or cellulose butyrate; vinyl resin such as polyvinyl alcohol, polyvinyl acetate, polyvinyl butyral, polyvinyl acetate acetal, or polyvinyl pyrrolidone; acryl resin such as poly(meth)acrylate or poly(meth)acrylamide; polyurethane resin; polyamide resin; polyester resin; urea-formaldehyde (UF) resin; phenol-formaldehyde (PF) resin; melamine-formaldehyde (MF) resin; or methylene diphenyl diisocyanate (MDI) resin, but the present invention is not limited thereto.

The thermal transmittance of the core substrate 110c may be less than 20 W/m²K, 19 W/m²K, 18 W/m²K, 17 W/m²K, 16 W/m²K, 15 W/m²K, or 14 W/m²K, including all ranges and subranges therebetween.

The thickness of the core substrate 110c may be, for example, about 1 mm to about 10 mm. In some embodiments, the thickness of the core substrate 110c may be about 1.5 mm to about 8 mm, about 1.5 mm to about 6 mm, or about 2 mm to about 4 mm, including all ranges and subranges therebetween.

When the core substrate 110c is too thin, the thermal transmittance of the core substrate 110c may become excessively high, and therefore, the insulation performance thereof may be insufficient. When the core substrate 110c is too thick, the volume and/or weight of the core substrate 110c may become excessive, and therefore, the glass laminate article 100 using the core substrate 110c may be limited to certain purposes.

The core substrate 110c does not include wood or a material derived from wood. For example, the core substrate 110c does not include an article, such as a medium density fiberboard (MDF), a high pressure laminate (HPL), a low density fiberboard (LDF), a high density fiberboard (HDF), or plywood, made of wood, wood particles, or wood fiber

The first metal sheet 110a is provided on the first surface 110sa of the core substrate 110c, and the second metal sheet 110b is provided on the second surface 110sb of the core substrate 110c.

The first metal sheet 110a and the second metal sheet 110b may independently include aluminum (Al), an aluminum alloy, titanium (Ti), a titanium alloy, zinc (Zn), a zinc alloy, or stainless steel. In some embodiments, the first metal sheet 110a and the second metal sheet 110b may include an aluminum sheet or an aluminum alloy sheet.

The thickness of each of the first metal sheet 110a and the second metal sheet 110b may be independently about 0.2 mm to about 0.8 mm. In some embodiments, the thickness of each of the first metal sheet 110a and the second metal sheet 110b may be independently about 0.3 mm to about 0.7 mm, about 0.35 mm to about 0.6 mm, or about 0.4 mm to about 0.5 mm, including all ranges and subranges therebetween.

When the first metal sheet 110a and the second metal sheet 110b are too thin, the first metal sheet 110a and the second metal sheet 110b may not have satisfactory strength and thus be easily damaged and hardly protect the core substrate 110c. When the first metal sheet 110a and the second metal sheet 110b are too thick, they may increase the weight and cost of products.

In some embodiments, the thickness of the first metal sheet 110a may be substantially the same as that of the second metal sheet 110b.

The first metal sheet 110a and the second metal sheet 110b may be bonded to the core substrate 110c via a first adhesive member 120a and a second adhesive member 120b, respectively. The first adhesive member 120a and the second adhesive member 120b may independently include, for example, a natural rubber adhesive composition, an α-olefin adhesive composition, an urethane resin adhesive composition, an ethylene-vinyl acetate resin emulsion adhesive composition, an ethylene-vinyl acetate resin hot melt adhesive composition, an epoxy resin adhesive composition, a vinyl chloride resin adhesive composition, a chloroprene rubber adhesive composition, a cyanoacrylate adhesive composition, a silicone adhesive composition, a styrene-butadiene rubber adhesive composition, a nitrile rubber adhesive composition, a nitrocellulose adhesive composition, a reactive hot melt adhesive composition, a phenol resin adhesive composition, a metamorphic silicone adhesive composition, a polyester hot melt adhesive composition, a polyamide resin hot melt adhesive composition, a polyimide adhesive composition, a polyurethane resin hot melt adhesive composition, a polyolefin resin hot melt adhesive composition, a polyvinyl acetate resin adhesive composition, a polystyrene resin adhesive composition, a polyvinyl alcohol adhesive composition, a polyvinyl pyrrolidone resin adhesive composition, a polyvinyl butyral adhesive composition, a polybenzimidazole adhesive composition, a polymethacrylate resin solvent adhesive composition, a melamine resin adhesive composition, an urea resin adhesive composition, or a resorcinol adhesive composition. Only one kind of adhesive composition may be used or at least two kinds of adhesive composition may be mixed.

The first adhesive member 120a and the second adhesive member 120b may have a thickness of about 0.01 μm to about 10 μm or about 0.05 μm to about 6 μm.

The glass substrate 110g is provided on the second metal sheet 110b. The glass substrate 110g may include aluminosilicate, alkali-aluminosilicate, borosilicate, alkali-borosilicate, aluminoborosilicate, alkali-aluminoborosilicate, soda lime, or other appropriate glass. For example, commercialized products, such as EAGLE XG® glass, Lotus™ glass, Willow® glass, Iris™ glass, and Gorilla® glass that are manufactured by Corning Incorporated, may be used for the glass substrate 110g.

The glass substrate 110g may be bonded to the second metal sheet 110b via a third adhesive member 120c.

The third adhesive member 120c may include an ethylene-vinyl acetate (EVA) copolymer, poly(vinyl butyral) (PVB), an optically clear adhesive (OCA), or a ultraviolet (UV) curable resin.

The UV curable resin may include a photoinitiator and a monomer or an oligomer. The photoinitiator may be initiated by UV radiation and polymerize the monomer or the oligomer.

For example, an epoxy monomer, vinyl ethers, cyclic ethers, or an acrylic monomer may be used for the monomer. The oligomer may include a (meth)acrylate oligomer, a polyester (meth)acrylate oligomer, an acryl (meth)acrylate oligomer, a polyurethane (meth)acrylate oligomer, an epoxy acrylate oligomer, or a silicone acrylate oligomer but is not limited thereto.

for example, benzoin ethers, amines, diazonium salt, iodonium salt, sulfonium salt, or a metallocene compound may be used for the photoinitiator, but embodiments are not limited thereto.

The UV curable resin may be a fluid that has a viscosity of about 100 cps to about 8000 cps at a temperature of 25° C., and may be coated by spin coating or a doctor-blade method. Thereafter, the glass substrate 110g may be bonded to the second metal sheet 110b by attaching the glass substrate 110g to the second metal sheet 110b and curing the UV curable resin by UV radiation.

The third adhesive member 120c may have high light transmittance. Especially, the third adhesive member 120c may have high light transmittance in a visible wavelength range. For example, the third adhesive member 120c may have a light transmittance of at least 90%, at least 92%, at least 94%, at least 96%, or at least 98% in a wavelength of 550 nm.

The bowing of the glass laminate article 100 which is measured after the glass laminate article 100 undergoes one of Corning Environmental Assessments #1 through #4, which will be described below, may be about 0.3 mm/m to about 1.8 mm/m.

In some embodiments, the bowing of the glass laminate article 100 measured after the glass laminate article 100 undergoes Corning Environmental Assessment #1 may be about 0.5 mm/m to about 1.3 mm/m, about 0.55 mm/m to about 1.2 mm/m, about 0.60 mm/m to about 1.2 mm/m, or about 0.70 mm/m to about 1.2 mm/m, including all ranges and subranges therebetween.

In some embodiments, the bowing of the glass laminate article 100 measured after the glass laminate article 100 undergoes Corning Environmental Assessment #2 may be about 1.3 mm/m to about 1.8 mm/m, about 1.4 mm/m to about 1.8 mm/m, about 1.5 mm/m to about 1.7 mm/m, or about 1.6 mm/m to about 1.7 mm/m, including all ranges and subranges therebetween.

In some embodiments, the bowing of the glass laminate article 100 measured after the glass laminate article 100 undergoes Corning Environmental Assessment #3 may be about 0.3 mm/m to about 0.8 mm/m, about 0.3 mm/m to about 0.7 mm/m, about 0.3 mm/m to about 0.65 mm/m, or about 0.3 mm/m to about 0.6 mm/m, including all ranges and subranges therebetween.

In some embodiments, the bowing of the glass laminate article 100 measured after the glass laminate article 100 undergoes Corning Environmental Assessment #4 may be about 0.6 mm/m to about 1.4 mm/m, about 0.7 mm/m to about 1.3 mm/m, about 0.8 mm/m to about 1.25 mm/m, or about 0.9 mm/m to about 1.2 mm/m, including all ranges and subranges therebetween.

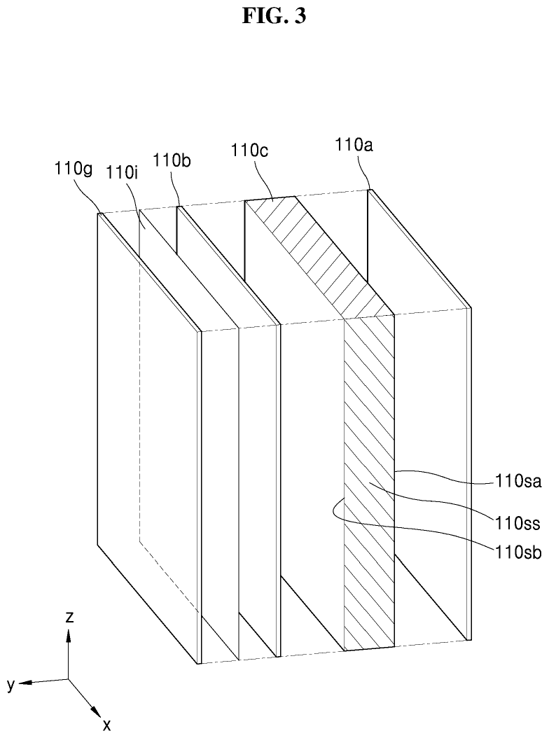

FIG. 3 is an exploded perspective view of a glass laminate article 200 according to one or more embodiments. The glass laminate article 200 is the same as the glass laminate article 100 of FIG. 1, except that the glass laminate article 200 further includes an image layer 110i. Therefore, descriptions below will be focused on this difference, and redundant description will be omitted.

Referring to FIG. 3, the glass laminate article 200 may further include the image layer 110i between the glass substrate 110g and the second metal sheet 110b. In some embodiments, the image layer 110i may include a pigment layer formed by printing a pattern of a single color or two or more colors on a surface of the second metal sheet 110b using inkjet printing or the like. In some embodiments, the image layer 110i may include a print film for image on which a pattern of a single color or two or more colors is printed.

The print film may include a polypropylene (PP) film, a polyethylene terephthalate (PET) film, or a stack film thereof. Besides the above films, the print film may further include other polymer resin layers. For example, the print film may include a polystyrene (PS) film, an acrylonitrile butadiene styrene (ABS) resin film, high density polyethylene (HDPE), low density polyethylene (LDPE), polyvinyl chloride (PVC), polyethylene naphthalate, polybutylene terephthalate, polycarbonate (PC), or other polymer resin layers including a copolymer thereof.

The image layer 110i may have a thickness of about 10 μm to about 400 μm, about 15 μm to about 370 μm, or about 20 μm to about 350 μm. When the image layer 110i is too thin, it is difficult to handle the image layer 110i, thereby decreasing productivity. When the image layer 110i is too thick, the thickness of the glass laminate article 200 excessively increases, and accordingly, it is difficult to achieve the satisfactory appearance of products.

When the image layer 110i includes a pigment layer, the image layer 110i may be directly printed on the surface of the second metal sheet 110b. When the image layer 110i includes a print film on which an image is printed, the image layer 110i may be attached to the surface of the second metal sheet 110b via an adhesive member such as the first adhesive member 120a or the second adhesive member 120b. In this case, the third adhesive member 120c may be between the image layer 110i and the glass substrate 110g.

Hereinafter, the configuration and effects of embodiments will be described in detail with reference to specific experimental examples and comparative examples, but these experimental examples are provided for clear understanding of the embodiments not for purpose of limitation.

### EXPERIMENTAL EXAMPLE 1

A polyethylene foam having a thickness of 3 mm was used as a core substrate, and an aluminum sheet having a thickness of 0.5 mm was attached to each of both sides of the polyethylene foam. Thereafter, a glass laminate article was manufactured by attaching Gorilla® glass having a thickness of 0.25 mm, which was manufactured by Corning Incorporated, to the aluminum sheet on one side of the polyethylene foam using an OCA.

### EXPERIMENTAL EXAMPLE 2

A glass laminate article was manufactured using the same method as that used in Experimental Example 1, except that poly(vinyl butyral) (PVB) instead of an OCA was used to attach Gorilla® glass.

### EXPERIMENTAL EXAMPLE 3

A glass laminate article was manufactured using the same method as that used in Experimental Example 1, except that a silica composite material having a thickness of 3 mm was used as a core substrate and polyester methacrylate resin was used to attach Gorilla® glass.

### EXPERIMENTAL EXAMPLE 4

A glass laminate article was manufactured using the same method as that used in Experimental Example 3, except that EVA was used to attach Gorilla® glass.

### COMPARATIVE EXAMPLE 1

A glass laminate article was manufactured by attaching Gorilla® glass having a thickness of 0.25 mm, which was manufactured by Corning Incorporated, to a side of a Deco steel sheet having a thickness of 0.5 mm using an OCA.

### COMPARATIVE EXAMPLE 2

A Deco steel sheet having a thickness of 0.5 mm was attached to a side of an MDF having a thickness of 6 mm. Thereafter, a glass laminate article was manufactured by attaching Gorilla® glass having a thickness of 0.25 mm, which was manufactured by Corning Incorporated, to the Deco steel sheet using an OCA.

### COMPARATIVE EXAMPLE 3

A glass laminate article was manufactured by further attaching an aluminum foil having a thickness of 40 μm to an opposite side of the MDF in Comparative Example 2.

### COMPARATIVE EXAMPLE 4

A glass laminate article was manufactured by attaching Gorilla® glass having a thickness of 0.25 mm, which was manufactured by Corning Incorporated, to a side of an HDF (high density fiberboard) stack having a thickness of 3 mm using PVB.

### COMPARATIVE EXAMPLE 5

A glass laminate article was manufactured by further attaching an aluminum foil having a thickness of 40 μm to an opposite side of the HDF stack in Comparative Example 4.

A thermal transmittance test and Corning Environmental Assessments #1 through #4 were performed on the respective glass laminate articles of Experimental Examples 1 through 4 and Comparative Examples 1 through 5, as described below, and the results thereof are shown in Table 1. When there was delamination or a damage (e.g., a crack or a fracture) in a glass substrate, Fail was recorded. In otherwise cases, Pass was recorded.

<Thermal Transmittance Test>

The thermal transmittance of each glass laminate article was measured for 72 hours according to ISO 9869 and ASTM C1155 and C1046 standards.

<Corning Environmental Assessment #1>

To assess resistance to high temperature, to which a glass laminate article may be exposed in transit, the glass laminate article was put under a temperature of 60° C. for 30 days and then checked for delamination or a damage (e.g., a crack or a fracture) in a glass substrate.

<Corning Environmental Assessment #2>

To assess resistance to high humidity, to which a glass laminate article may be exposed during storage, the glass laminate article was put under 90% relative humidity and a temperature of 30° C. for 30 days and then checked for delamination or a damage (e.g., a crack or a fracture) in a glass substrate.

<Corning Environmental Assessment #3>

To assess resistance to low humidity, to which a glass laminate article may be exposed during storage, the glass laminate article was put under 30% relative humidity and a temperature of 30° C. for 30 days and then checked for delamination or a damage (e.g., a crack or a fracture) in a glass substrate.

<Corning Environmental Assessment #4>

To assess resistance to a temperature change, to which a glass laminate article may be exposed in transit, a thermal shock test was performed. A process of maintaining 60° C. for 11 hours, cooling down to −40° C. for an hour, maintaining −40° C. for 11 hours, and heating back to 60° C. for an hour was set as one cycle, and the glass laminate article was let go through 14 cycles and then checked for delamination or a damage (e.g., a crack or a fracture) in a glass substrate.

TABLE 1

| | Thermal | | | | |
|---|---|---|---|---|---|
| | transmittance | Corning Environmental Assessment | | | |
| | (W/m²K) | #1 | #2 | #3 | #4 |
| Experimental | 13.3 | Pass | Pass | Pass | Pass |
| Example 1 | | | | | |
| Experimental | 14.5 | Pass | Pass | Pass | Pass |
| Example 2 | | | | | |
| Experimental | 15.7 | Pass | Pass | Pass | Pass |
| Example 3 | | | | | |
| Experimental | 14.1 | Pass | Pass | Pass | Pass |
| Example 4 | | | | | |
| Comparative | 2938.5 | Pass | Pass | Pass | Pass |
| Example 1 | | | | | |
| Comparative | 21.5 | Pass | Fail | Pass | Fail |
| Example 2 | | | | | |
| Comparative | 23.4 | Pass | Pass | Pass | Fail |
| Example 3 | | | | | |
| Comparative | 28.1 | Pass | Pass | Pass | Pass |
| Example 4 | | | | | |
| Comparative | 28.4 | Pass | Pass | Pass | Pass |
| Example 5 | | | | | |

As shown in Table 1, the glass laminate articles of Experimental Examples 1 through 4 had thermal transmittance ranging from about 13.3 W/m²K to about 15.7 W/m²K and passed all Corning Environmental Assessments #1 through #4.

The glass laminate article of Comparative Example 1 had notably high thermal transmittance, and the glass laminate articles of Comparative Examples 2 through 5 had relatively high thermal transmittance as compared to the glass laminate articles of Experimental Examples 1 through 4. In particular, the glass laminate articles of Comparative Examples 2 and 3 had less poor thermal transmittance than the glass laminate articles of Comparative Examples 4 and 5 but did not pass some Corning environmental assessments.

A bowing test was performed on the glass laminate articles of Experimental Examples 1 through 4 and Comparative Examples 1 through 5, as described below, and the results thereof are shown in Table 2.

<Bowing Test>

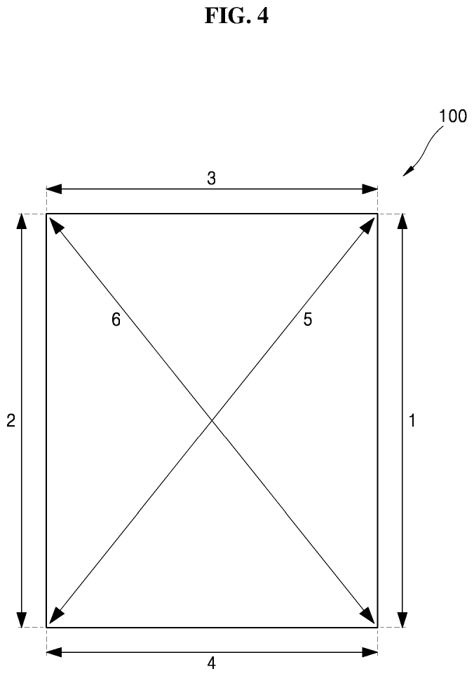

After Corning Environmental Assessments #1 through #4 were performed, the bowing of each glass laminate article was measured on a cradle that tilts 75 degrees with respect to the ground. As shown in FIG. 4, opposite ends of a glass laminate article were connected with a fine thread in each of six directions, and a maximum distance between the thread and the glass laminate article was measured in a direction perpendicular to each of the six directions and converted into a length per meter. The biggest value among maximum distances measured and converted with respect to the six directions was defined as the bowing of the glass laminate article.

TABLE 2

| | Bowing after Corning Environmental Assessment | | | |
|---|---|---|---|---|
| | (mm/m) | | | |
| | #1 | #2 | #3 | #4 |
| Experimental | 1.1 | 1.67 | 0.55 | 1.1 |
| Example 1 | | | | |
| Experimental | 0.75 | 1.62 | 0.48 | 0.98 |
| Example 2 | | | | |
| Experimental | 0.74 | 1.66 | 0.45 | 1.1 |
| Example 3 | | | | |
| Experimental | 0.57 | 1.61 | 0.31 | 0.95 |
| Example 4 | | | | |
| Comparative | N/A | N/A | N/A | N/A |
| Example 1 | | | | |
| Comparative | 8.8 | 13.3 | 2.2 | Unmeasurable |
| Example 2 | | | | |
| Comparative | 2.21 | 1.24 | 0.86 | Unmeasurable |
| Example 3 | | | | |
| Comparative | 5.5 | 7.8 | 1.1 | 2.33 |
| Example 4 | | | | |
| Comparative | 0.55 | 1.1 | 0 | Unmeasurable |
| Example 5 | | | | |

As shown in Table 2, the glass laminate articles of Experimental Examples 1 through 4 had a reasonable bowing of 1.1 mm/m or less, except for Corning Environmental Assessment #2 performed under high humidity conditions. Even in Corning Environmental Assessment #2 under high humidity conditions, the bowing of the glass laminate articles of Experimental Examples 1 through 4 ranged from 1.61 mm/m to 1.67 mm/m.

Meanwhile, in the cases of the glass laminate articles of Comparative Examples 2, 3, and 5, during Corning Environmental Assessment #4, liquid was condensed in an edge portion, increasing the volume of the edge portion, and therefore, bowing was not measurable.

In the case of the glass laminate article of Comparative Example 1, since the Deco steel sheet had a thin thickness of 0.5 mm and was flexible, the Deco steel sheet tended to be flat due to its own dead load. Accordingly, it is meaningless to measure the bowing of the glass laminate article, and therefore, “not applicable (N/A)” was recorded.

The glass laminate article of Comparative Example 4 had two to five times greater bowing than the glass laminate articles of Experimental Examples 1 through 4 and showed relatively poorer bowing characteristics.

According to embodiments, a glass laminate article has high insulation performance and low bowing.

In a first embodiment, the present disclosure provides a glass laminate article comprising: a core substrate having a first surface, a second surface opposite to the first surface, and a side surface between the first surface and the second surface; a first metal sheet on the first surface; a second metal sheet on the second surface; a glass substrate on the second metal sheet; and an adhesive member bonding the glass substrate to the second metal sheet, wherein the core substrate has lower thermal conductivity than a medium density fiberboard (MDF).

In a second embodiment, the glass laminate article of embodiment 1 further comprise the core substrate includes a polymer having a foam structure.

In a third embodiment, the glass laminate article of embodiment 1 or 2, wherein the core substrate includes a composite material including a metal oxide or a semimetal oxide.

In a fourth embodiment, the glass laminate article of embodiment 3, wherein the composite material includes at least one of silica, titania, alumina, zirconia, and ceria.

In a fifth embodiment, the glass laminate article of any of embodiments 1 to 4, wherein the first metal sheet and the second metal sheet include at least one of aluminum and an aluminum alloy.

In a sixth embodiment, the glass laminate article of embodiment 5, further comprising an image layer between the second metal sheet and the adhesive member.

In a seventh embodiment, the glass laminate article of any of embodiments 1 to 6, wherein a thickness of the first metal sheet is about 0.2 mm to about 0.8 mm.

In an eighth embodiment, the glass laminate article of embodiment 7, wherein the thickness of the first metal sheet is substantially equal to a thickness of the second metal sheet.

In a ninth embodiment, the glass laminate article of any of embodiments 1 to 8, wherein a thickness of the glass substrate is about 0.1 mm to about 0.7 mm.

In a tenth embodiment, the present disclosure provides a glass laminate article comprising: a core substrate having a first surface, a second surface opposite to the first surface, and a side surface between the first surface and the second surface; a first sheet on the first surface, the first sheet having a thickness of about 0.2 mm to about 0.8 mm; a glass substrate on the second surface; and an adhesive member between the second surface and the glass substrate, wherein the first sheet includes at least one of an aluminum sheet and an aluminum alloy sheet.

In an eleventh embodiment, the glass laminate article of embodiment 10, further comprising a second sheet between the second surface and the adhesive member, wherein the second sheet includes at least one of an aluminum sheet and an aluminum alloy sheet.

In a twelfth embodiment, the glass laminate article of embodiment 11, wherein a thickness of the second sheet is substantially equal to the thickness of the first sheet.

In a thirteenth embodiment, the glass laminate article of any of embodiments 10 to 12, wherein thermal transmittance of the core substrate is less than 18 W/m2K.

In a fourteenth embodiment, the glass laminate article of any of embodiments 10 to 13, wherein the glass substrate includes at least one of aluminosilicate, alkali-aluminosilicate, borosilicate, alkali-borosilicate, aluminoborosilicate, alkali-aluminoborosilicate, soda lime glass, and alkali-free glass.

In a fifteenth embodiment, the glass laminate article of any of embodiments 10 to 14, wherein the adhesive member includes at least one of ethylene-vinyl acetate resin, poly(vinyl butyral), ultraviolet (UV) curable resin, and an optically clear adhesive (OCA).

In a sixteenth embodiment, the present disclosure provides a glass laminate article comprising: a core substrate having a thermal transmittance of less than 18 W/m2K; a first metal sheet and a second metal sheet respectively on opposite surfaces of the core substrate and each having a thickness of about 0.2 mm to about 0.8 mm; and a glass substrate on the first metal sheet.

In a seventeenth embodiment, the glass laminate article of embodiment 16, further comprising an image layer between the glass substrate and the first metal sheet.

In an eighteenth embodiment, the glass laminate article of embodiment 16 or 17, wherein a thickness of the glass substrate is about 0.1 mm to about 0.7 mm.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A glass laminate article comprising:
a core substrate having a first surface, a second surface opposite to the first surface, and a side surface between the first surface and the second surface, wherein the core substrate includes a polymer having a foam structure having a thermal transmittance of less than 18 W/m²K;
a first metal sheet on the first surface, wherein a thickness of the first metal sheet is 0.2 mm to 0.8 mm;
a second metal sheet on the second surface; wherein the first metal sheet and the second metal sheet include at least one of metal and an metal alloy
a glass substrate on the second metal sheet, wherein a thickness of the glass substrate is 0.1 mm to 0.7 mm;
an adhesive member bonding the glass substrate to the second metal sheet, and
an image layer between the second metal sheet and the adhesive member.

2. (canceled)

3. The glass laminate article of claim 1, wherein the core substrate includes a composite material including a metal oxide or a semimetal oxide.

4. The glass laminate article of claim 3, wherein the composite material includes at least one of silica, titania, alumina, zirconia, and ceria.

5.-7. (canceled)

8. The glass laminate article of claim 1, wherein the thickness of the first metal sheet is substantially equal to a thickness of the second metal sheet.

9.-13. (canceled)

14. The glass laminate article of claim 1, wherein the glass substrate includes at least one of aluminosilicate, alkali-aluminosilicate, borosilicate, alkali-borosilicate, aluminoborosilicate, alkali-aluminoborosilicate, soda lime glass, and alkali-free glass.

15. The glass laminate article of claim 1, wherein the adhesive member includes at least one of ethylene-vinyl acetate resin, poly(vinyl butyral), ultraviolet (UV) curable resin, and an optically clear adhesive (OCA).

16.-18. (canceled)

19. The glass laminate of claim 3, wherein the metal oxide or the semimetal oxide are powder form, immobilized with a binder, to define a panel shape.

20. The glass laminate of claim 19, wherein the binder includes at least one of: cellulose resin, vinyl resin, acryl resin, polyurethane resin; polyamide resin; polyester resin; urea-formaldehyde (UF) resin; phenol-formaldehyde (PF) resin; melamine-formaldehyde (MF) resin; and methylene diphenyl diisocyanate (MDI) resin.

21. The glass laminate of claim 1, wherein the thickness of the core substrate is 1 mm to 10 mm.

22. The glass laminate of claim 21, wherein the thickness of the core substrate is 1.5 mm to 6 mm.

23. The glass laminate of claim 1, wherein the adhesive member has a thickness of 0.01 μm to 10 μm.

24. The glass laminate of claim 23, wherein the adhesive member has a thickness of 0.05 μm to 6 μm.

25. The glass laminate of claim 1, wherein the first metal sheet and second metal sheet are independently selected from: aluminum (Al), an aluminum alloy, titanium (Ti), a titanium alloy, zinc (Zn), a zinc alloy, or stainless steel.

26. The glass laminate of claim 1, wherein the first metal sheet and the second metal sheet are identical materials, selected from either: aluminum or aluminum alloy.

27. The glass laminate of claim 1, wherein the image layer includes a printed pigment layer on the second metal sheet.

28. The glass laminate of claim 1, wherein the image layer includes a print film.

29. The glass laminate of claim 28, wherein the print film includes: a polypropylene (PP) film, a polyethylene terephthalate (PET) film, or a stack film thereof.

30. The glass laminate of claim 1, wherein the image layer has a thickness of 10 μm to 400 μm.

31. The glass laminate of claim 1, wherein the image layer has a thickness of 20 μm to 350 μm.
